(19) United States
(12) Patent Application Publication
(10) Pub. No.: US 2024/0107320 A1
(43) Pub. Date: Mar. 28, 2024

(54) AUTOMATED VENDOR AGNOSTIC CBSD/CPE PROVISIONING

(71) Applicant: CHARTER COMMUNICATIONS OPERATING, LLC, St. Louis, MO (US)

(72) Inventors: Saran Khalid, Denver, CO (US); MohammedYusuf Shaikh, Denver, CO (US)

(73) Assignee: CHARTER COMMUNICATIONS OPERATING, LLC, St. Louis, MO (US)

(21) Appl. No.: 17/954,220

(22) Filed: Sep. 27, 2022

(51) Int. Cl. H04W 16/10; H04W 72/04

(52) U.S. Cl. CPC H04W 16/10; H04W 72/0493; H04W 84/042

(57) ABSTRACT

Various embodiments comprise systems, methods, and apparatus providing substantially automated provisioning and provisioning management of CPE within a system using unlicensed spectrum so as to ensure that the CPE operate only within an allowed spectral region irrespective of CPA capability. The automated system utilizes an identification of CPE being installed to automatically determine CPE capability, configure the CPE as needed to avoid CPE operation outside of the allowed spectral region, and generate approval-ready CPE credentials suitable for use by a Spectrum Access System (SAS).

### FIELD OF THE DISCLOSURE

The present disclosure generally relates to wireless communications systems, and more particularly, to automatically constraining CPE operational capabilities and enabling approval of CPE credentials prior to registration of the CPE with an SAS.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Customer premises equipment (CPE) such as provided to the homes/businesses of a cable company or multiple system operator (MSO) include CPE capable of operating using unlicensed spectrum such as the Citizens Broadband Radio Service (CBRS) band at ˜3.5-3.7 GHz. This spectrum is used by Citizens Broadband Radio Service Devices (CBSDs) registered with a Spectrum Access System (SAS) capable of adapting CBSD operation in accordance with Generic Authorized Access (GAA) requirements, network congestion, network interference and the like. The SAS performs various functions such as determining/assigning frequencies, operating parameters (e.g., transmission power on those frequencies), and the like to CBSDs such as within a mobile network.

CPE produced by various vendors is capable of use in the US and many other countries. For example, many vendors provide CPE capable of operating over a very wide spectral region (e.g., 3 GHz-6 GHz) which includes spectral bands that may not be utilized by CPE within the US (e.g., outside of the 3.5-3.7 GHz CBRS band). For example, some CPE may be built to work in in a range of frequency for example band 42 is 3.4 GHz to 3.6 GHz but products built to operate in this band can also operate in band 48 spectrum provided the chipset is designed to operate in this band. This is similar to the use of WiFi band in 2.4 GHz. For example, in the US channel 1 though 11 could be used where as in most parts of the world, channels 1 though 14 may be used.

As such, prior to CPE receiving spectrum grants from the SAS, the US Federal Communications Commission (FCC) has mandated that it is first necessary to configure the CPE to operate within the required spectrum limits. Further, the FCC mandate includes a tedious, error-prone, manual process of configuring CPE to operate only within the CBRS band.

Per the FCC, each type of CPE may be characterized as a Category A device or a Category B device. If a category B device, then the CPE it must be installed by a certified professional installer (CPI) and registered with the system. Even if the CPE is characterized as a Category A device (typically a fully indoor device having, therefore, limited range), it must be registered with the system.

### SUMMARY

Various deficiencies in the prior art are addressed by systems, methods, and apparatus providing substantially automated provisioning or provisioning management of CPE within a system using unlicensed spectrum so as to ensure that the CPE operate only within an allowed spectral region irrespective of CPA capability. The automated system utilizes an identification of CPE being installed to automatically determine CPE capability, configure the CPE as needed to avoid CPE operation outside of the allowed spectral region, and generate approval-ready CPE credentials suitable for use by a Spectrum Access System (SAS).

A method according to one embodiment for managing customer premises equipment (CPE) access to Citizens Broadband Radio Service (CBRS) spectrum, comprises: at a network management entity, in response to receiving installation parameters associated with an identified CPE, determining whether operational capability of the identified CPE exceeds an allowed CBRS operational range including an allowed CBRS bandwidth operational range; responsive to CPE operational capability exceeding the allowed CBRS operational range, determining a CPE configuration for constraining operation of the identified CPE to the allowed CBRS operational range; and responsive to CPE operational capability not exceeding the allowed CBRS operational range, enabling approval of credentials of the identified CPE for registration of the identified CPE with a Spectrum Access System (SAS). The allowed CBRS bandwidth operation range may comprise an allowed band of CBRS transmit frequencies.

The allowed CBRS operation range may further include at least one allowed transmit power level within the CBRS bandwidth operational range; and responsive to CPE operational capabilities exceeding the at least one allowed transmit power level within the CBRS bandwidth operational range, determining a CPE configuration for constraining operation of the identified CPE to the at least one allowed transmit power level within CBRS bandwidth operational range. The allowed transmit power level within the CBRS bandwidth operational range(s) may be defined using a location of the CPE and an installation height of the CPE.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a simplified representation of a fixed wireless network benefiting from the various embodiments;

FIG. 2 depicts a flow diagram of a method in accordance with the embodiments; and

FIG. 3 depicts block diagram of an exemplary computing device suitable for use in various embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments are directed to a substantially automated system for provisioning CPE within a system using unlicensed spectrum so as to ensure that the CPE operate only within an allowed spectral region, illustratively the Citizens Broadband Radio Service (CBRS) frequency bands (currently from 3.5 to 3.7 GHz) for CPE configured to operate as Citizens Broadband Radio Service Devices (CBSDs).

The automated system utilizes an identification of CPE being installed to automatically determine the capabilities of the CPE (e.g., including an ability to operate at frequencies outside of the CBRS frequency bands), configure the CPE to avoid operating outside of the allowed frequencies (spectral region), and generate approval-ready CPE credentials suitable for use by a Spectrum Access System (SAS) configured for determining available CBRS operating frequencies, and assigning the CPE available CBRS operating frequencies and operating parameters (e.g., transmission power on those frequencies).

This various embodiments are directed to mechanisms and methods providing credentials of the CPE to SAS as well as core network, wherein modified messaging structures/flows are used to provide details about the CPE device(s) so that the device(s) may be automatically approved for provisioning to operate in the CBRS band. In particular, various embodiments provide a method that automates CBSD installation and setup process.

In various embodiments, a CPI approval module is configured to automate/manage CB SD (CPE) installation and setup processes by, illustratively, transmitting key credentials of the CBSD (CPE) to an SAS and transmitting credentials/capability information to a network core so as to enable interaction between the network core and SAS to: using a message from SAS, determine device authenticated for specific CBRS channels; using capability information (directly supplied, related to model number, related to equipment id), determine CBSD capability such as supplied via a lookup in a database, supplied via spreadsheet including data for many CBSDs, or supplied by other means; and provisioning CBSD (e.g., CPE) in accordance with capability and authenticated channels to control power configuration, channel configuration, random-access channel (RACH)/shared channel processing and so on.

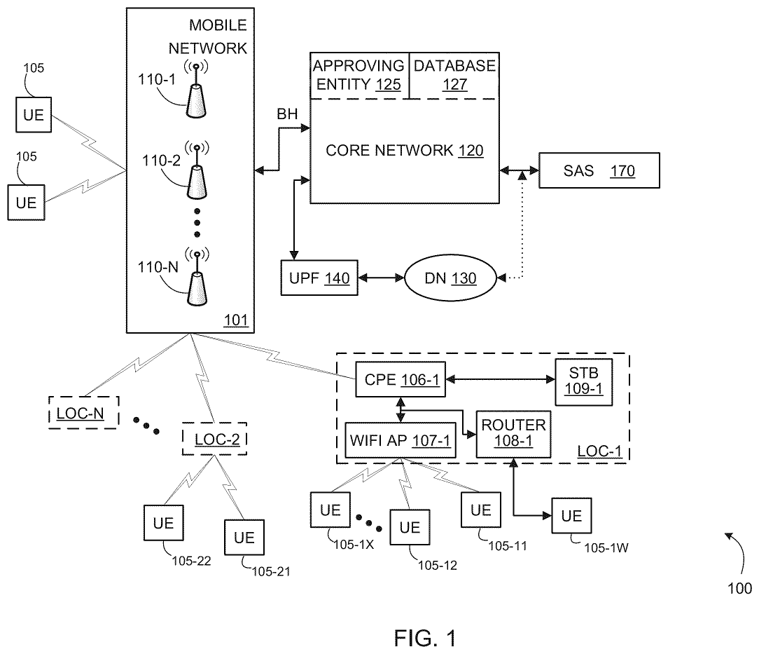

FIG. 1 depicts a simplified representation of a fixed wireless network benefiting from the various embodiments. Specifically, FIG. 1 depicts a fixed wireless access (FWA) network 100 in which a plurality of 5G base stations or network nodes 110 (eNBs, gNBs) forming a mobile network 101 are configured to wirelessly communicate with, and provide backhaul services to, user equipment (UE) 105, customer premises equipment (CPE) 106, and/or other devices. The CPE 106 may support respective local WiFi access points (WAPs) 107 and the traffic associated with respective Wifi devices connected thereto.

As depicted in FIG. 1, a 5G core network 120 is depicted in a simplified form as comprising a number of core network nodes or network functions (NFs) such as described in relevant standards documents such as the 3GPP standards for 5G (e.g. 3GPP 23.501 and 23.502). One or more data networks (DN) 130 having application servers (AS) connected thereto may be connected to the 5G core network 120 through user plane functions (UPFs) such as UPF 140. The depicted 5G core network 120 may also include various other network node functions (not shown for simplicity) along with their relevant interfaces.

As depicted in FIG. 1, UE 105 and CPE 106 are configured for wirelessly communicating with the mobile network 101 (e.g., a 5G radio network), illustratively comprising a plurality of base stations, gNBs, or eNBs depicted herein as network nodes 110-1 through 110-N, which are connected to the 5G core network 120 via back haul (BH) and/or other communications links. The gNB may be formed as logical nodes or groupings of resources at a radio access network (R)AN or RAN such as implemented at network nodes 110 within the mobile network 101. The gNB formed thereat may be configured with more or fewer RAN resources so at to have features and/or capabilities selected in response to the type and number of UE and CPE connected thereto, the type of services being provided thereby, and so on.

At least some of the UE 105 may also function as WiFi Access Terminals (ATs) for wirelessly communicating with wireless access points (WAPs) 107 deployed at various locations LOC and supported thereat by customer premises equipment (CPE) 106 configured for wirelessly communicating with the mobile network 101.

For example, a first location LOC-1 is depicted as including CPE 106-1 configured to support a WAP 107-1, a router 108-1, and a set top box (STB) 109-1. The WAP 107-1 is depicted as communicating with a plurality of wireless devices, namely, UE 105-11 through 105-1X. The router 108-1 is depicted as communicating with wired UE 105-1W. The STB 109-1 may be a standard cable television STB configured to deliver broadcast, video on-demand (VOD), and/or other media related services. Further, the STB 109-1 may include a local digital video recorder (DVR) configured to periodically core programming from various channels accessible to the STB 109 such as in accordance with the service level agreement (SLA) of the subscriber associated with the location LOC-1.

The network nodes 110 may comprise macrocells, small cells, microcells and the like such as eNodeBs (eNBs), cellular network base stations, repeaters, and similar types of provider equipment or logical radio nodes (e.g., gNBs) derived therefrom. The network nodes 110 and various RAN resources may comprise resources using unlicensed spectrum such as citizens broadband radio service (CBRS) spectrum. The network nodes 110 may, in various embodiments, include mid-band (e.g., 3.5 GHz) gNBs, low-band (e.g., under 1 GHz) gNBs, or a combination of mid-band and low-band gNBs.

For purposes of this discussion, it will be assumed that the network nodes 110 have Citizens Broadband Radio Service Device (CBSD) capability, wherein allocations of CBRS spectrum are provided via a Spectrum Access System (SAS) 170. Generally speaking, the SAS 170 communicates with the 5G core network 120 (optionally with the DN 130) and is configured to control access to the CBRS frequency band for CBSD network nodes 110, UE 105, CPE 106 and other CBSD devices. Generally speaking, the SAS 170 is configured to ensure that the CBRS frequency band is allocated for CBSD use, and that such use is adapted government requirements, network congestion, network interference and the like.

It is noted that the various embodiments are described within the context of spectrum access being granted to CBSDs, such as base stations, eNBs, gNBs, CPE, UE, WAPs, and the like via one or more SAS 170 operating in accordance with, illustratively, a CBSD-SAS discovery, authentication, registration, spectrum inquiry, spectrum grant, heartbeat, grant relinquishment, grant suspension, deregistration, and/or other procedures such as that described in the WINNF-TS-0016 standards document. Similar processes may be used in other managed spectrum environments, and the various embodiments may be modified by those skilled in the art and informed by the teachings herein to be operational in such other managed spectrum environments in a substantially similar manner to that described herein with respect to the CBRS/CBSD environment.

The WAPs 107 may comprise 802.11xx (e.g., 802.11b, 802.11a, 802.11g, 802.11n, 802.11ac, 802.11ax and so on) wireless access points at homes, businesses, or other location that are configured to communicate with supporting CPE 106. In various embodiments, a network services provider utilizes numerous such access points distributed over a “coverage footprint” to provide network services to mobile devices such as the UE 105 discussed herein.

Each network node 110 provides network services to UE 105 and CPE 106 via respective radio bearer (channels/resources) which are managed by various Radio Resource Management functions, such as Radio Bearer Control, Radio Admission Control, Connection Mobility Control, Scheduling of UE/CPE in both uplink and downlink, assignment of bandwidth parts (BWPs) to UE/CPE and so on.

The UE 105 may comprise any type of wireless device configured for use in accordance with the various embodiments, such as user terminals (e.g., mobile phones, laptops, tablets and the like), fixed wireless access devices (e.g., set top boxes, digital video recorders, stationary computing devices and the like), Internet of Things (IoT) devices (e.g., sensors, monitoring devices, alarm system devices and the like), and/or other wireless devices. The UE 105 may include UE that use licensed spectrum, unlicensed spectrum such as CBRS spectrum, or a combination of licensed and unlicensed spectrum. In the case of network nodes 110 having CB SD capability, allocations of CBRS spectrum are provided via SAS 170.

As depicted in FIG. 1, a Spectrum Access System (SAS) 170 communicates with the core network 120 (optionally with the DN 130) and is configured to control access to the CBRS frequency band for RANs and other CBSD devices such as network nodes 110, UE 105, and CPE 106. Generally speaking, the SAS 170 is configured to ensure that the CBRS frequency band is allocated for CBSD use, and that such use is adapted government requirements, network congestion, network interference and the like.

Prior to any CPE 106 (or UE 105) being provisioned and brought under the control of the network, the network is unaware of the capabilities of the CPE 106, such as with respect to frequencies outside the CBRS band, overall transmission capabilities, and so on. Further, absent any configuration to the contrary, the CPE 106 will likely assume it can transmit within the entirety of its transmission spectrum capability, without any knowledge of regional restrictions in terms of frequency limitations, transmit power limitations, and so on.

Therefore, when new CBSD CPE is to be installed at a location, the credentials associated with the new CPE must be approved prior to the credentials being used by the SAS to grant spectrum to the CPE. The approval of the CPE credentials may include ensuring that CPE operational capabilities are constrained consistent with the CBRS frequency bands, transmission power, and so on.

In the case of installation parameters associated with an identified CPE, a determination is made as to whether any operational capability of the identified CPE exceeds an allowed CBRS operational range, such as allowed CBRS bandwidth operational range, allowed band(s) of CBRS transmit frequencies, one or more allowed transmit power levels within the CBRS bandwidth operational range or band(s) of CBRS transmit frequencies, and so on. If a CPE operational capability exceeds an allowed CBRS operational range, then a determination is made as to a CPE configuration that will operate to constrain CPE operation such that it is within the corresponding allowed CBRS operational range(s). The determined configuration may be subjected to approval by an approving entity, after which CPE having approved credentials may interact with an SAS to begin CBSD operation.

An approving entity suitable for use in approving CPE credentials may be a certified professional installer (CPI) reviewing data associated with multiple CPE installed by field technicians in accordance with requirements defined by the CPI and/or FCC. In this case, the CPI may use an application (e.g., a “CPI Approval App” function/module executed on a computing platform such as a mobile device or other computing device) to review installation parameters associated with one or many CPE field installations so as to rapidly approve or disapprove the CPE credentials.

An approving entity suitable for use in approving CPE credentials may be a management function implemented in hardware or a combination of hardware and software (e.g., a management entity or server operably coupled to the core network), and configured to determine whether the installation parameters associated with the one or many CPE field installations is consistent with the criteria used by CPIs to approve such CPE.

In one embodiment, such as where CPE 106 is installed by a field technician at a location LOC, the field technician may use an application (e.g., a “FT Install App” function/module executed on a computing platform such as a mobile device or other computing device) to extract, record, or otherwise obtain the installation parameters associated with the CPE being installed, and to provide the installation parameters to various management entities and/or an approving entity.

The CPI App and FT Install App may comprise separate applications modules/functions invoked at separate computing devices, or they may be combined into a single function/module invoked at one computing device. For purposes of this discussion, it will be assumed that the CPI App and FT Install App are invoked at UE 105 of a field technician and a CPI, and that the CPI App invoked at the UE 105 of the CPI is used to enable rapid scanning/approval of a large number of CPE installations prior to registration of the CPE with one or more relevant SAS 170.

The installation parameters provided to the management/approving entity via the installation app technician may comprise minimum installation parameters, such as the serial number of the CPE and the height at which the CPE is installed at the location. The serial number or other CPE-identifying information may be manually entered by the field technician or scanned via the mobile device/app as a bar code, Q-code, or alphanumeric code. Similarly, the height at which the CPE is installed may be manually entered by the field technician, or determined via an altimeter or GPS or other function of the mobile device/app.

The installation parameters provided to the management/approving entity via the installation app technician may comprise a subset of the parameters associated with an RegistrationRequest message object, which is provided to the SAS 170 to request registration of a CBSD device with the SAS 170 (e.g., a CPE 106 being installed). The subset of parameters (key parameters) of the RegistrationRequest message object comprise the installation parameters associated with CPI-type approval; namely, cbsdSerialNumber, latitude, longitude, height, heightType, indoorDeployment, antennaAzimuth, antennaDowntilt, antennaGain, and antennaBeamwidth.

The RegistrationRequest message object parameters (including the key parameters as noted above) comprise: userId, fccId, callSign, cbsdSerialNumber, cbsdCategory, airinterface, measCapability, groupingParam, eirpCapability, horizontalAccuracy, verticalAccuracy, latitude, longitude, height, heightType, indoorDeployment, antennaAzimuth, antennaDowntilt, antennaGain, antennaBeamwidth, antennaModel, vendor, cbsdModel, software Version, hardware Version, firmwareVersion.

Various elements or portions thereof depicted in FIG. 1 and having functions described herein are implemented at least in part as computing devices having communications capabilities, including for example the UE 105, CPE 106, WAP 107, network nodes 110, SAS 170, UPF 140, and various network nodes and network functions of the core network 120. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network equipment used to implement network functions at a network core, network equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The network equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

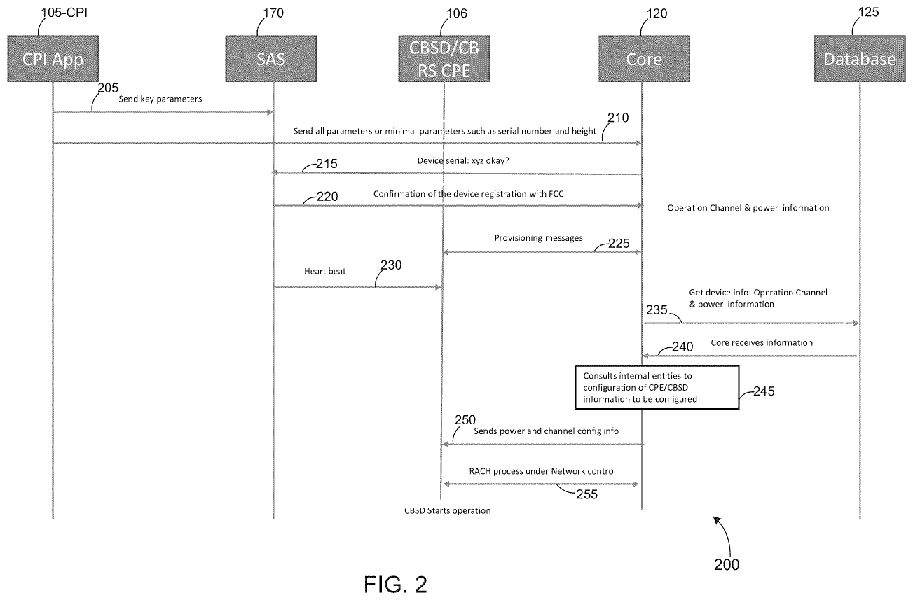

FIG. 2 depicts a flow diagram of a method in accordance with the embodiments. Specifically, FIG. 2 depicts a method 200 by which installation parameters associated with newly installed CPE are processed in accordance with an embodiment. As previously noted, when new CB SD CPE is to be installed at a location, the credentials associated with the new CPE must be approved prior to the credentials being used by the SAS to grant spectrum to the CPE. The approval of the CPE credentials may include ensuring that CPE operational capabilities are constrained consistent with the CBRS frequency bands, transmission power, and so on.

At step 205, key installation parameters are transmitted by the CPI app 105-CPI to the SAS 170 as part of a RegistrationRequest message object. The key installation parameters may comprise cbsdSerialNumber, latitude, longitude, height, heightType, indoorDeployment, antennaAzimuth, antennaDowntilt, antennaGain, and antennaBeamwidth.

At step 210, at least minimum installation parameters (e.g., serial number and installation height) are transmitted by the CPI app 105-CPI to the core network 120 to retrieve therefrom information pertaining to the CPE as known to the core. As previously noted, the core network 120 may include, or be in communication with, one or both of an approving entity 125 (or management entity performing various functions such described herein with respect to an approving entity) and a CPE database 127. CPE location may determined using CPE installation address (e.g., customer address), a GPS detector built into the CPE (or a device used by an installer), or other means.

In response to receiving minimum installation parameters (or all installation parameters, or a subset thereof), the database 127 is accessed using the received CPE serial number to extract therefrom information associated with the CPE, such as the CPE type, model, capability configuration, operating parameters, and so on, including any differences in this information with respect to FCC Category A operation (indoor operation) and FCC Category B operation (outdoor operation at specific installation heights). Both categorizations require FCC registration, Category B operation further requires CPI approval of CPE configuration; namely, CPI determination that the CPE configuration is such that CPE will operate within the required spectrum, transmission power, and other limitations. Some of these limitations are general in nature, whereas others are location specific.

At step 215, the core network 120 transmits to the SAS 170 data indicative of the CPE (e.g., identified via serial number) being approved or not approved for use as a Category A and/or Category B device.

At step 220, after the SAS 170 registered the CPE with the FCC (or confirms such registration), the SAS 170 transmits to the network core 120 a message indicative of the FCC registration of the CPE.

At step 225, in response to the core network 120 receiving confirmation of FCC registration of the CPE, the core network 120 initiates a provisioning process between the core network 120 and the CPE 106. The conclusion of the provisioning process is the CPE 106 being authorized to communicate as a device within the network.

At step 230, after the CPE 106 has received approved spectrum grants but before the CPE has received authorization from the SAS 170 to transmit within the granted spectrum, the CPE 106 periodically transmits heartbeat requests to the SAS 170 to request such authorization.

At step 235, the core network 120 requests from the database 125 various operational channel, power, and other information pertaining to the CPE 106, which information is received via step 240 and processed at step 245.

At step 245, the operational channel, power, and other information pertaining to the CPE 106 is used to determine the CBSD operating parameters of the CPE 106, such as determining which potential CBRS frequencies are to be used, at what transmission power level, and so on. That is, if the CPE has operational capabilities that exceed allowed a CBRS operational range (e.g., more CBRS transmit frequencies than allowed, greater CBRS transmit frequency power, etc.), then a CPE configuration is determined and invoked so as to constrain operation of the identified CPE to the allowed CBRS operational range.

At step 250, the determined CBSD operating parameters of the CPE 106 are transmitted by the core network 120 to the CPE 106, which parameters are used to establish radio channel processing/activity by the CPE 106 under control of the core network 120.

At step 260, the RACH process proceeds under network control.

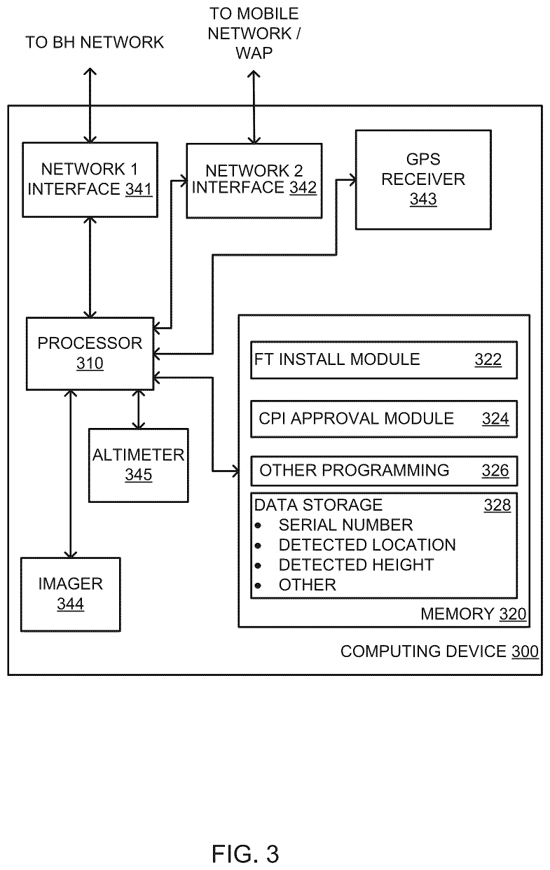

FIG. 3 depicts block diagram of an exemplary computing device suitable for use in various embodiments or portions thereof. In particular, the computing device 300 as depicted is configured for operation as a UE 105 and therefore is shown as including programming modules associated with various UE 105 functions such as described herein. It is noted that the computing device 300 may be readily adapted to implement programming modules, methods, and the like associated with the CPE 106, WAP 107, network nodes 110, SAS 170, UPF 140, approving entity 125, database 127, and various network nodes and network functions of the core network 120.

Referring to FIG. 3, the computing device 300 is configured to implement functions associated with UE 105, illustratively a mobile device configured to invoke either or both of, as described above, the CPI App and functions and the FT App and functions. The UE 105 (computing device 300) as depicted is able to communicate via either of a mobile network (e.g., licensed or unlicensed spectrum used to provide 3G/4G/LTE/5G mobile services) or a WiFi network (e.g., 802.11xx) such as used within the fixed wireless network of FIG. 1.

Specifically, the computing device 300 of FIG. 3 is depicted as including one or more processor(s) 310, a memory 320, a backhaul network interface/transceiver 341, a mobile network or wireless access point (WAP) interface/transceiver 342, a global positioning system (GPS) receiver 343, and, optionally, either or both of an imager 344 and altimeter 345.

The processor(s) 310 is coupled to, and adapted to cooperate with, the memory 320, the communications interfaces/transceivers 341-342, the GPS receiver 343, optional imager 344 optional altimeter 345, as well as various other support circuitry (not shown) to provide the various functions as described herein.

Memory 320 includes random access memory (RAM), read only memory (ROM), and/or flash memory, and stores information in the form of data and instructions. These instructions that can be executed by processor(s) 310. Various types of instructions may be stored in memory 320. For instance, memory 320 may store instructions that control the operation of communication interfaces/transceivers 341-342, the GPS receiver 343, the optional imager 344, the optional altimeter 345, and perform the various location detection, imaging, height determination, and other functions disclosed and discussed herein with respect to the figures, as well as the operation of other elements within the UE 105 (or other entity implemented using the structure of the computing device 300 of FIG. 3).

The BH (network 1) interface 341 as depicted herein are configured to support backhaul communications with the core network 120 such as via the mobile network 101 or other devices/mechanisms.

The mobile network or wireless access point (WAP) interface 342 as depicted herein is configured to support communications with via a mobile network protocol or a Wi-Fi protocol.

The GPS receiver 343 is configured to receive and process GPS location information or similar information from a satellite-based location system to determine thereby a location of the UE 105 or CPE 106 (e.g., CPE 106 being installed by a field tech using the UE 105 as a field tech UE-105-FT, such as including a location function for determining the CPE location for use by the SAS 170 and core network as described above).

The optional imager 344 may comprise a camera configured to photograph or otherwise take images of a CPE 106 being installed, such as a serial number, bar code, Q-code and the like associated with the CPE 106 so as to enable identification of the CPE.

The optional altimeter 345 is configured to detect the altitude or height above ground of a current location of the UE 105 or CPE 106. The altimeter 345 may comprise a barometric altimeter, GPS altimeter, or an altimeter formed using some other suitable technology. In some embodiments, an altimeter function is provided using the GPS receiver 343 by itself or in cooperation with the optional altimeter 145. In various embodiments, the optional altimeter 345 detects the altitude and uses the detected altitude to automatically infer an installation height of CPE 106.

The memory 320, generally speaking, stores programs, data, tools and the like that are adapted for use in providing various functions as described herein with respect to the figures. For example, the memory 320 is depicted as storing instructions associated with a FT installation module 322 and/or CPI approval module 324 (each module invoking various functions such as described above with respect to FIGS. 1-2), as well as other programming 326, which instructions cause the respective modules either individually or in combination to perform the various functions of the embodiments described herein.

For example, in various embodiments the CPI approval module 324 is configured to automate CBSD (CPE 106) installation and setup processes (e.g., manage provisioning of CPE) by, illustratively, transmitting key credentials of the CBSD (CPE 106) to the SAS 170 and transmitting credentials/capability information to network core 120 so as to enable interaction between the network core 120 and SAS 170 to: using a message from SAS, determine device authenticated for specific CBRS channels; using capability information (directly supplied, related to model number, related to equipment id), determine CBSD capability such as supplied via a lookup in a database, supplied via spreadsheet including data for many CBSDs, or supplied by other means; and provision CBSD (e.g., CPE 106) in accordance with capability and authenticated channels to control power configuration, channel configuration, RACH processing and so on.

The memory 320 stores instructions controlling the transmission and reception of data via the various interfaces 341-342 in accordance with the appropriate communications protocols, data and control formats, timing requirements, packet structures and the like.

The memory 320 may also include data storage 320 for storing for each CPE 106 the scanned serial number, detected location, detected height, and/or other information associated with CPE 106 being installed.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method for managing customer premises equipment (CPE) access to Citizens Broadband Radio Service (CBRS) spectrum, comprising:
at a network management entity, in response to receiving installation parameters associated with an identified CPE, determining whether operational capability of the identified CPE exceeds an allowed CBRS operational range including an allowed CBRS bandwidth operational range;
responsive to CPE operational capability exceeding the allowed CBRS operational range, determining a CPE configuration for constraining operation of the identified CPE to the allowed CBRS operational range; and
responsive to CPE operational capability not exceeding the allowed CBRS operational range, enabling approval of credentials of the identified CPE for registration of the identified CPE with a Spectrum Access System (SAS).

2. The method of claim 1, wherein the allowed CBRS bandwidth operation range comprises an allowed band of CBRS transmit frequencies.

3. The method of claim 1, wherein the allowed CBRS operation range further includes allowed CPE transmit power level at one or more CBRS transmit frequencies.

4. The method of claim 3, wherein allowed CPE transmit power level at CBRS transmit frequencies is determined with respect to CPE location and installation height.

5. The method of claim 4, wherein installation parameters associated with an identified CPE include a respective installation height detected via an altimeter associated with the identified CPE.

6. The method of claim 4, wherein installation parameters associated with an identified CPE include a respective location detected via a global position system (GPS) receiver associated with the identified CPE.

7. The method of claim 1, further comprising:
at a network management entity, in response to determining that the identified CPE is authorized for communications within the wireless network, transmitting a corresponding device authentication message to the SAS;
at the network management entity, in response to receiving confirmation that the identified CPE is registered with the FCC, transmitting toward the identified CPE a provisioning message configured to enable CBRS communication by the identified CPE, and any determined CPE configuration for constraining operation of the identified CPE to the allowed CBRS operational range.

8. The method of claim 1, wherein the installation parameters associated with an identified CPE are received from a computing device having associated with it an approving entity configured approve the configuration of the identified CPE as constraining operation of the identified CPE to the allowed CBRS operational range.

9. The method of claim 6, wherein the computing device is configured to execute thereon an application configured to determine installation parameters associated with an identified CPE.

10. The method of claim 1, wherein an approving entity is configured to enable approval of credentials of the identified CPE for registration thereof with the SAS in response to determining that identified CPE operational capabilities do not exceed an allowed CBRS operational range.

11. The method of claim 1, wherein an approving entity is configured to enable approval of credentials of the identified CPE for registration thereof with the SAS in response to determining that identified CPE constrained operational capabilities do not exceed an allowed CBRS operational range.

12. A system for managing customer premises equipment (CPE) access to Citizens Broadband Radio Service (CBRS) spectrum, the CPE being configured upon installation to be provisioned for providing core network services to user equipment (UE) attached thereto using Citizens Broadband Radio Service (CBRS) spectrum, comprising:
an approving entity configured to enable approval of credentials of installed CPE for registration thereof with a Spectrum Access System (SAS) in response to determining that operational capabilities of installed CPE do not exceed an allowed CBRS operational range.

13. The system of claim 12, wherein for CPE having operational capabilities exceeding the allowed CBRS operational range, the approving entity is further configured to enable approval of credentials of installed CPE for registration thereof with a Spectrum Access System (SAS) in response to determining that constrained operational capabilities of installed CPE do not allow CPE operation exceeding an allowed CBRS operational range.

14. The system of claim 12, wherein the approving entity is further configured to determine, for CPE having operational capabilities exceeding an allowed CBRS operational range, a corresponding CPE configuration for constraining CPE operation to the allowed CBRS operational range.

15. The system claim 12, wherein the allowed CBRS operational range comprises at least one of an allowed CBRS bandwidth operational range, an allowed band of CBRS transmit frequencies, and an allowed transmit power level at one or more of the CBRS transmit frequencies.

16. The system claim 15, wherein allowed transmit power level within the CBRS bandwidth operational range is determined using a location of the CPE and an installation height of the CPE.

17. The system claim 11, wherein the approving entity, in response to installed CPE having transmit power level capabilities exceeding an allowed transmit power at one or more CBRS transmit frequencies, determines a CPE configuration for constraining CPE operation to the allowed transmit power level.

18. The system claim 11, wherein:
the approving entity, in response to determining that the identified CPE is authorized for communications within the wireless network, transmitting a corresponding device authentication message to the SAS; and
the approving entity, in response to receiving confirmation that the identified CPE is registered with the FCC, transmitting toward the identified CPE a provisioning message configured to enable CBRS communication by the identified CPE, and the determined CPE configuration for constraining operation of the identified CPE to the allowed operational range.

19. The system claim 11, wherein:
the installation parameters associated with installation of an identified CPE are received from a computing device having associated with it an approving entity; and
the approving entity is configured to approve a CPE configuration for constraining operation of the identified CPE to the allowed operational range.

20. A tangible and non-transitory computer readable storage medium storing instructions which, when executed by a computing device associated with a network node, adapt the operation of the computing device to provide a method for managing customer premises equipment (CPE) access to Citizens Broadband Radio Service (CBRS) spectrum, comprising:
at a network management entity, in response to receiving installation parameters associated with an identified CPE, determining whether operational capability of the identified CPE exceeds an allowed CBRS operational range including an allowed CBRS bandwidth operational range;
responsive to CPE operational capability exceeding the allowed CBRS operational range, determining a CPE configuration for constraining operation of the identified CPE to the allowed CBRS operational range; and
responsive to CPE operational capability not exceeding the allowed CBRS operational range, enabling approval of credentials of the identified CPE for registration of the identified CPE with a Spectrum Access System (SAS).
